(19) United States
(12) Patent Application Publication
(10) Pub. No.: US 2007/0230182 A1
(43) Pub. Date: Oct. 4, 2007

(54) Led module

(76) Inventors: Yun Tai, Taipei City (TW); Ruey-Feng Tai, Changhua City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/390,094

(22) Filed: Mar. 28, 2006

(51) Int. Cl. F21V 29/00

(52) U.S. Cl. 362/294

(57) ABSTRACT

A LED module having a heat sink with a stepped top recess, a LED fixedly mounted in the stepped top recess of the heat sink, two metal conduction plates affixed to the heat sink at two opposite sides, two lead wires respectively connected between the metal conduction plates and the positive and negative terminals of the LED, a light transmittance resin molded on the stepped top recess over the light emitting diode, and a lens holder fastened to the heat sink and carrying an optical lens in vertical alignment with the light emitting diode.

### BACKGROUND OF THE INVENTION

1. Field of the Invention:

The present invention relates to a LED (light emitting diode) and more particularly, to a LED module that dissipates heat quickly during operation.

2. Description of the Related Art:

In recent decades, human beings consume energy heavily, resulting in an energy crisis. Nowadays, scientists in different countries are trying hard to develop new energy and every-saving products. In consequence, various petroleum substitutes have been developed, the utilization of solar power has been enhanced, and various low power consumption type fuel engines and motors and power-saving lighting fixtures have been created. Nowadays, LEDs (light emitting diodes) have been intensively used to substitute for conventional incandescent, bulbs and fluorescent bulbs in various fields for the advantage of low power consumption.

The lower power consumption characteristic of LEDs is well known. Following fast development of semiconductor technology, high brightness LEDs are developed for use in many fields for illumination. For example, LEDs have been intensively used in motor vehicles for vehicle lights.

However, a LED must be packaged with a light transmittance resin before application. Because a high brightness LED releases much heat during operation and is enclosed in the package, heat cannot be quickly dissipated during the operation.

### SUMMARY OF THE INVENTION

The present invention has been accomplished under the circumstances in view. It is therefore the main object of the present invention to provide a LED (light emitting diode) module, which dissipates heat quickly during the operation of the LED (light emitting diode). According to one aspect of the present invention, the LED module comprises a heat sink, which has a stepped top recess, a LED fixedly mounted in the stepped top recess of the heat sink, two metal conduction plates affixed to the heat sink at two opposite sides, two lead wires respectively connected between the metal conduction plates and the positive and negative terminals of the LED, a light transmittance resin molded on the stepped top recess over the light emitting diode, and a lens holder fastened to the heat sink and carrying an optical lens in vertical alignment with the light emitting diode. According to another aspect of the present invention, the heat sink is covered with an insulation layer, therefore the LED and the metal conduction plates can be directly fastened to the heat sink without the use of an external PC board or insulating substrate, and heat can directly be dissipated from the LED through the heat sink during the operation of the LED. According to still another aspect of the present invention, the heat sink has the bottom wall thereof covered with a tin solder layer for bonding to a metal block.

### BRIEF DESCRIPTION OF THE DRAWINGS

FIG. 1A is an exploded view of a LED module in accordance with a first embodiment of the present invention.

FIG. 1B is a sectional assembly view of the LED module in accordance with the first embodiment of the present invention.

FIG. 2 corresponds to FIG. 1A, showing the two metal conduction plates fastened to the heat sink.

FIG. 3 is a perspective assembly view of the LED module in accordance with the first embodiment of the present invention.

FIG. 4 is an exploded view of a LED module in accordance with a second embodiment of the present invention.

FIG. 5A is an exploded view of a LED module in accordance with a third embodiment of the present invention.

FIG. 5B is a sectional assembly view of a part of the LED module in accordance with the third embodiment of the present invention.

FIG. 6 is a schematic sectional view showing a LED module bonded to a meta block in accordance with a fourth embodiment of the present invention.

FIG. 7 is a schematic sectional view of a part of a LED module in accordance with a fifth embodiment of the present invention.

FIG. 8A is a schematic sectional view of a part of a LED module in accordance with a sixth embodiment of the present invention.

FIG. 8B is a top plain view of the metal conduction plate in accordance with the sixth embodiment of the present invention.

FIG. 9A is a schematic sectional view of a part of a LED module in accordance with a seventh embodiment of the present invention.

FIG. 9B is a top plain view of the metal conduction plate in accordance with the seventh embodiment of the present invention.

FIG. 10A is an exploded view of a LED module in accordance with an eighth embodiment of the present invention.

FIG. 10B is a sectional assembly view of the LED module in accordance with the eighth embodiment of the present invention.

### DETAILED DESCRIPTION OF THE PREFERRED EMBODIMENT

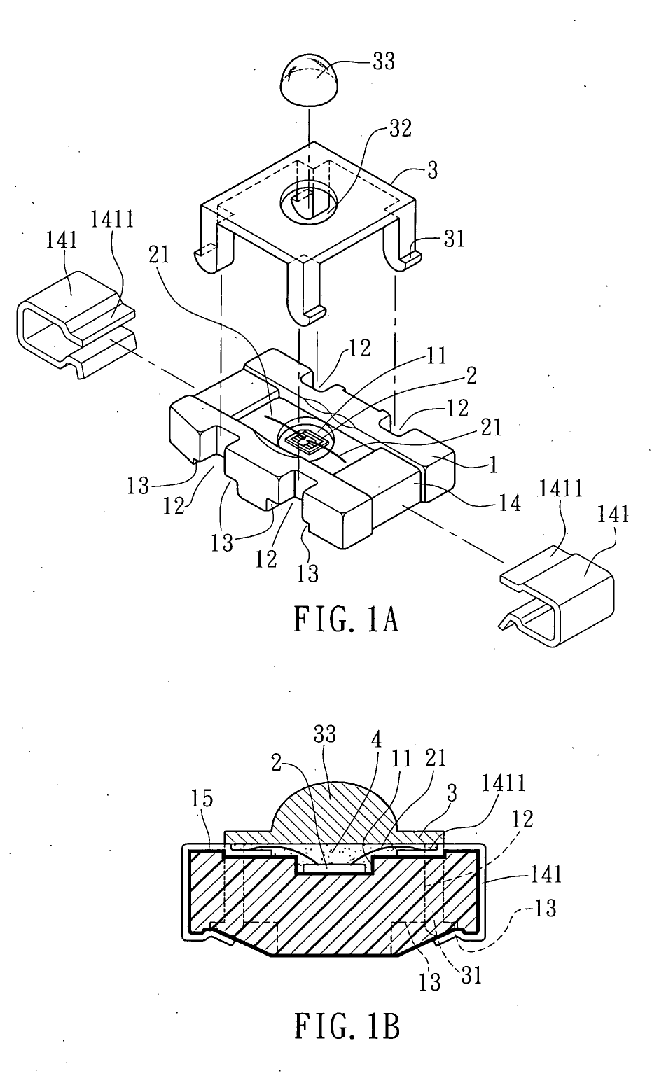

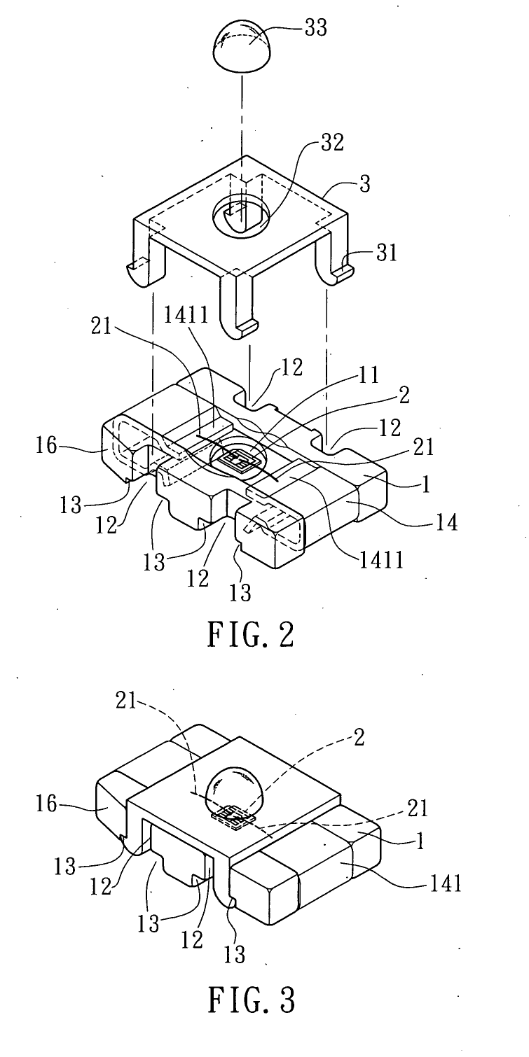

Referring to FIGS. 1A, 1B, 2 and 3, a LED module in accordance with a first embodiment of the present invention is shown comprising a heat sink 1, a LED (Light Emitting Diode) 2 mounted in the heat sink 1, and a lens holder 3 fastened to the heat sink 1 and holding an optical lens 33 corresponding to the LED 2. The heat sink 1 has a stepped top recess 11, which holds the LED 2, a plurality of side holes 12 symmetrically disposed at two opposite sides thereof, a plurality of bottom retaining notches 13 formed on the bottom wall corresponding to the side holes 12, and two locating grooves 14 symmetrically formed on the other two opposite sides thereof. Further, the outside wall of the heat sink 1 is covered with an insulation layer 15. A light transmittance resin 4 is molded on the stepped top recess 11 over the LED 2, keeping the LED 2 embedded in the light transmittance resin 4. The lend holder 3 has a plurality of bottom hooks 31 respectively inserted through the side holes 12 at two opposite lateral sides of the heat sink 1 and hooked on respective bottom retaining notches 13 in the side holes 12, and a center hole 32 vertically aimed at the LED 2. The optical lens 33 is fastened to the center hole 32 of the lens holder 3. Two metal conduction plates 141 are respectively fastened to the locating grooves 14 of the heat sink 1. Two lead wires 21 are respectively connected between the two metal conduction plates 141 and the positive and negative terminals of the LED 2. The metal conduction plates 141 each have a front positioning portion 1411 curved downwards and then forwards for positioning in the stepped top recess 11 of the heat sink 1 and the bonding of the associate lead wire 21. Because the connection area between the front positioning portion 1411 of each metal conduction plate 141 and the associating lead wire 21 is kept in the stepped top recess 11 of the heat sink 1, the lead wires 21 are well protected against damage during further processing process. Further, the head sink 1 has a beveled edge 16 at one side for quick recognition of the positive/negative pole.

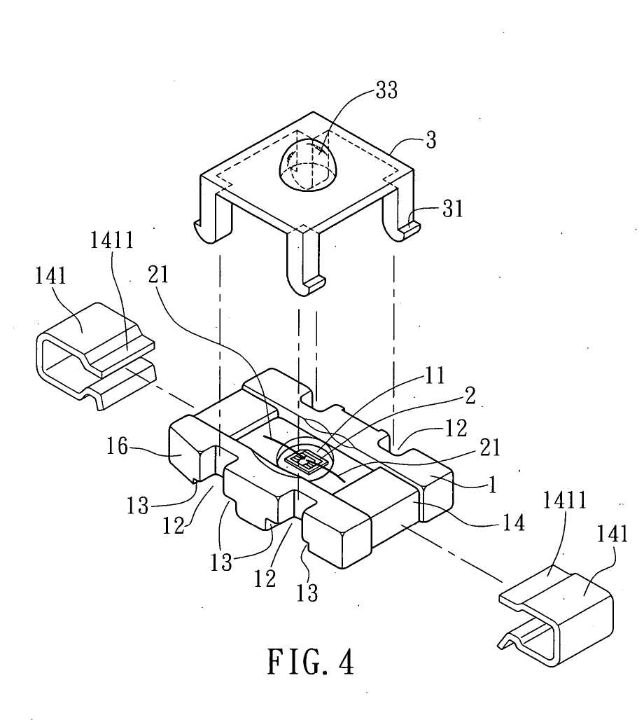

FIG. 4 shows a LED module in accordance with a second embodiment of the present invention. This embodiment is substantially similar to the aforesaid first embodiment with the exception that the optical lens 33 is formed integral with the lens holder 3.

Further, the heat sink 1 is made of a metal material of high coefficient of heat transfer good for heat exchange, for example, gold, silver, copper, iron, aluminum, or any of a variety of other suitable metal alloys. Further, the metal conduction plates 141 can be directly bonded to the locating grooves 14 of the heat sink 1, or formed on the locating grooves 14 of the heat sink 1 by printing or deposition technique.

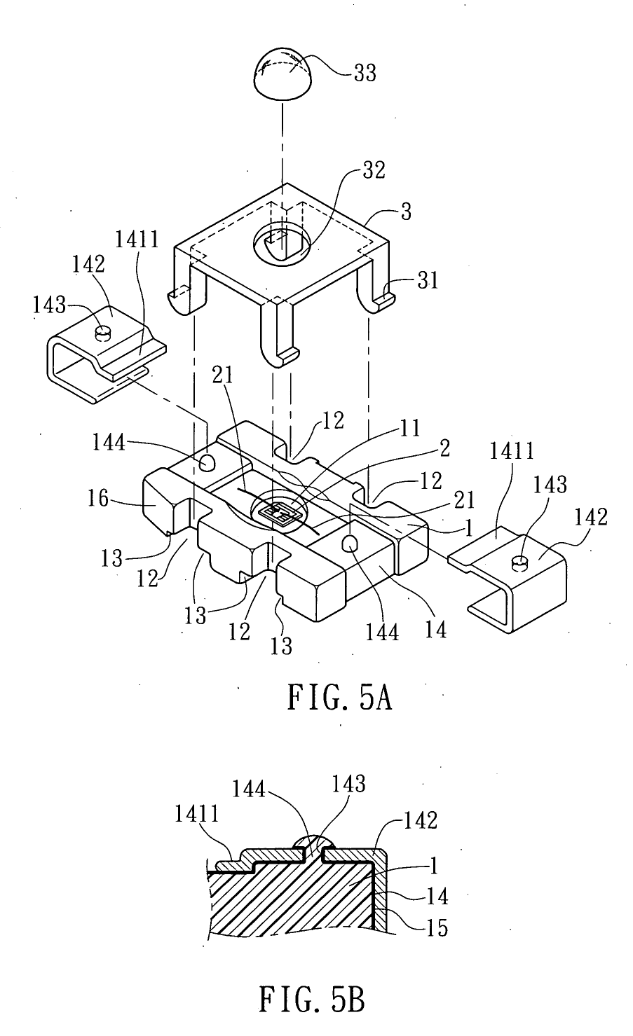

FIGS. 5A and 5B show a LED module in accordance with a third embodiment of the present invention. According to this embodiment, the heat sink 14 has two upright positioning rods 144 respectively suspending in the locating grooves 14, and the two metal conduction plates 142 each have a positioning hole 143 respectively coupled to the upright positioning rods 144. After the metal conduction plates 142 have been mounted in the locating grooves 14, the upright positioning rods 144 are respectively hammered down to affix the metal conduction plates 142 to the head sink 1.

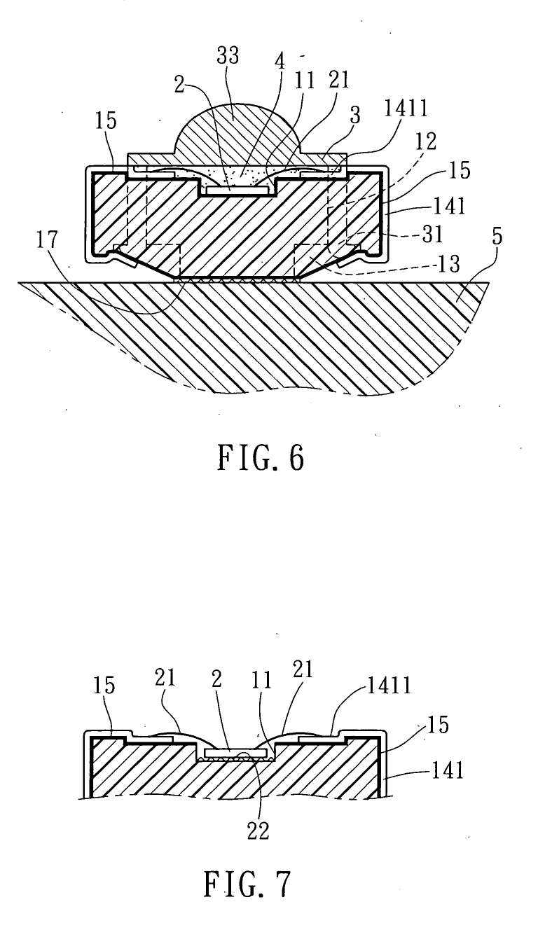

FIG. 6 shows a LED module in accordance with a fourth embodiment of the present invention. According to this embodiment, the heat sink 1 has a tin solder layer 17 formed on the bottom wall for soldering to a metal block 5 for quick dissipation of heat from the LED 2.

FIG. 7 shows a LED module in accordance with a fifth embodiment of the present invention. This embodiment eliminates the aforesaid insulation layer 15 from the heat sink 1; a tin solder layer 22 is directly covered on the stepped top recess 11; the LED 2 is directly soldered to the tin solder layer 22 in the stepped top recess 11.

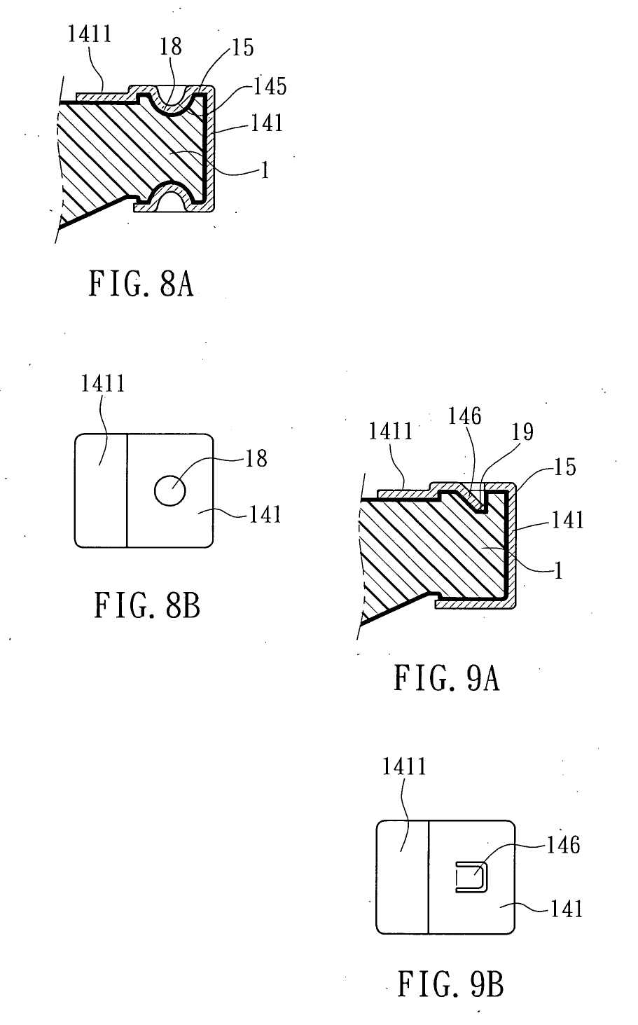

FIGS. 8A and 8B show a part of a LED module in accordance with a sixth embodiment of the present invention. According to this embodiment, each metal conduction plate 141 has two rounded protruding portions 18 respectively engaged into respective recessed retaining portions 145 at the top and bottom sides of the heat sink 1.

FIGS. 9A and 9B show a part of a LED module in accordance with a seventh embodiment of the present invention. According to this embodiment, each metal conduction plate 141 has a obliquely downwardly protruding hooked portion 19 engaged into a respective retaining groove 146 at the top side of the heat sink 1.

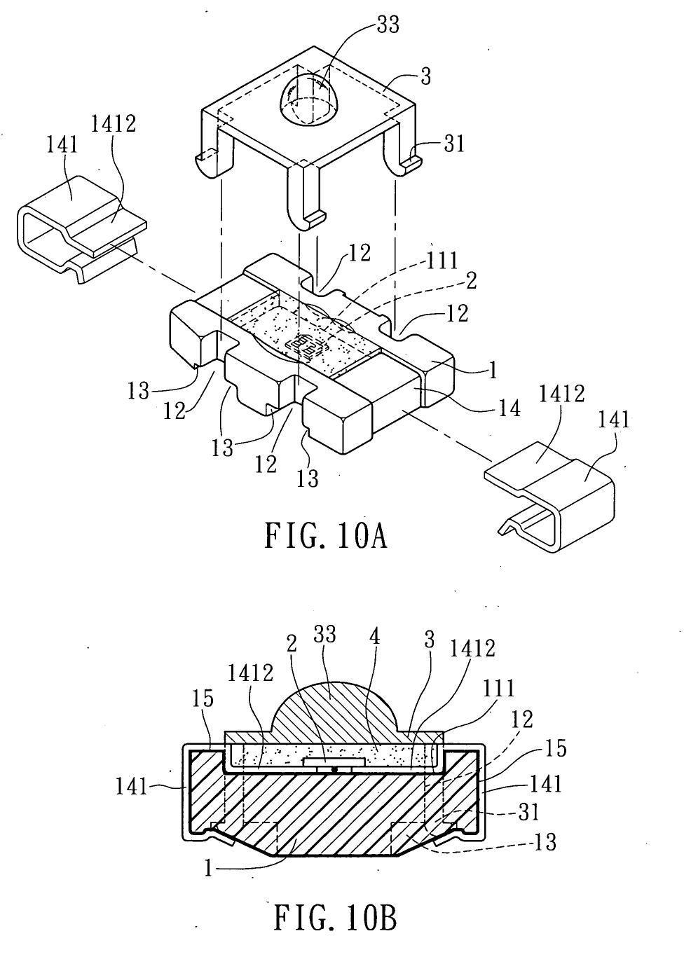

FIGS. 10A and 10B show a LED module in accordance with an eighth embodiment of the present invention. According to this embodiment, the heat sink 1 has a flat top recess 111; the metal conduction plates 141 each have a front extension portion 1412 closely attached to the flat top recess 111 in proximity to the center area of the flat top recess 111; the LED 2 is directly bonded to the front extension portions 1412 of the metal conduction plates 141; the light transmittance resin 4 is covered on the flat top recess 111 over the LED 2 and kept in flush with the topmost edge of the heat sink 1; the lens holder 3 has bottom hooks 31 respectively inserted through the side holes 12 at two opposite lateral sides of the heat sink 1 and hooked on respective bottom retaining notches 13 in the side holes 12, and holds an optical lens 33 in vertical alignment with the LED 2.

Although particular embodiments of the invention have been described in detail for purposes of illustration, various modifications and enhancements may be made without departing from the spirit and scope of the invention.

The invention claimed is:

1. A LED module comprising:
a heat sink, said heat sink having a stepped top recess in a top side thereof;
a light emitting diode fixedly mounted in said stepped top recess;
at least one pair of metal conduction plates affixed to said heat sink;
at least one pair of lead wires respectively connected between said at least one pair of metal conduction plates and the positive and negative terminals of said light emitting diode;
a light transmittance resin molded on said stepped top recess over said light emitting diode; and
a lens holder fastened to said heat sink, said lens holder carrying an optical lens in vertical alignment with said light emitting diode.

2. The LED module as claimed in claim 1, wherein said optical lens is formed integral with said lens holder.

3. The LED module as claimed in claim 1, wherein said lens holder has a center hole; said optical lens is fixedly mounted in said center hole.

4. The LED module as claimed in claim 1, wherein said heat sink has a plurality of side holes symmetrically disposed at two opposite sides thereof and a plurality of bottom retaining notches formed on a bottom wall thereof corresponding to said side holes; said lens holder has a plurality of bottom hooks respectively inserted into said side holes of said heat sink and hooked in said bottom retaining notches of said heat sink.

5. The LED module as claimed in claim 1, wherein said heat sink has at least one part of an outside wall thereof covered with an insulation layer.

6. The LED module as claimed in claim 1, wherein said heat sink is made of a metal material of high coefficient of heat transfer.

7. The LED module as claimed in claim 1, wherein said heat sink has two locating grooves symmetrically disposed at two opposite sides; said metal conduction plates are respectively fastened to said locating grooves of said heat sink.

8. The LED module as claimed in claim 1, wherein said metal conduction plates each have a positioning hole; said heat sink has two positioning rods respectively riveted to the positioning holes of said metal conduction plates.

9. The LED module as claimed in claim 1, wherein said heat sink has recessed retaining portions formed on top and bottom sides thereof for securing said metal conduction plates; said metal conduction plates each have a plurality of protruding portions respectively engaged into the recessed retaining portions of said heat sink.

10. The LED module as claimed in claim 1, wherein said heat sink has a plurality of retaining grooves at a top side thereof; said metal conduction plates each have at least one obliquely downwardly protruding hooked portion respectively engaged into the retaining grooves of said heat sink.

11. The LED module as claimed in claim 1, wherein said metal conduction plates are directly bonded to said heat sink.

12. The LED module as claimed in claim 1, wherein said metal conduction plates are formed on said heat sink by coating.

13. The LED module as claimed in claim 1, wherein said metal conduction plates each have a front positioning portion curved downwards and forwards and positioned in said stepped top recess of said heat sink; said lead wires are respectively bonded to the front positioning portions of said metal conduction plates.

14. The LED module as claimed in claim 1, wherein said heat sink has a bottom wall covered with a tin solder layer for bonding to a metal block.

15. The LED module as claimed in claim 1, wherein said heat sink has a beveled edge disposed at one side for quick recognition of the installation direction of said light emitting diode.

16. A LED module comprising:
a heat sink, said heat sink having a flat top recess in a top side thereof;
at least one pair of metal conduction plates affixed to said heat sink, said metal conduction plates each having a front extension curved downwards and forwards and positioned in said flat top recess of said heat sink;
a light emitting diode, said light emitting diode having positive and negative terminals thereof respectively bonded to the front extensions of said metal conduction plates;
a light transmittance resin molded on said flat top recess over said light emitting diode; and
a lens holder fastened to said heat sink, said lens holder carrying an optical lens in vertical alignment with said light emitting diode.

17. The LED module as claimed in claim 16, wherein said heat sink has at least one part of an outside wall thereof covered with an insulation layer.

18. The LED module as claimed in claim 16, wherein said optical lens is formed integral with said lens holder.

19. The LED module as claimed in claim 16, wherein said lens holder-has a center hole; said optical lens is fixedly mounted in said center hole.

20. The LED module as claimed in claim 16, wherein said heat sink is made of a metal material of high coefficient of heat transfer.
